(19) United States
(12) Patent Application Publication
(10) Pub. No.: US 2023/0012860 A1
(43) Pub. Date: Jan. 19, 2023

(54) Wall Support Structure And Thermal Transfer Reduction System

(71) Applicant: Robert Allen Dummer, Blythe, CA (US)

(72) Inventor: Robert Allen Dummer, Blythe, CA (US)

(21) Appl. No.: 17/374,566

(22) Filed: Jul. 13, 2021

(51) Int. Cl. E04C 3/36; E04B 1/76; E04B 2/70; B32B 3/30; B32B 21/04; B32B 7/08

(52) U.S. Cl. CPC E04C 3/36; E04B 1/76; E04B 2/70; B32B 3/30; B32B 21/04; B32B 7/08; E04B 2001/7679; B32B 2307/304; B32B 2607/00

(57) ABSTRACT

A wall support structure and thermal transfer reduction system 10 comprises a first support element 12 aligned and positioned closest to a first face 14 of a wall 16; a second support element 18 aligned and positioned closest to an opposing face 20 of the wall 16; and a thermal transfer reduction spacer element 22 aligned and positioned between the support elements.

The present invention relates an invention comprising elements that can be used together to provide support internally within walls for construction purposes, which also helps reduce thermal transfer between one face of a wall to the other face of the wall.

### BACKGROUND

It will be obvious that walls tend to require internal support structures. One support means used, for example, may be a vertically oriented length of wood.

However, there is a problem; if the piece of wood (or any support element, not limited to a length of wood) is aligned within the wall in such a way that one side of the support element is close to a first face of the wall, and the support element extends so that the other side of the support element is close to the opposing side of the wall, then a significant amount of heat/cold can be transferred from the environment that lies on one side of the wall, to the other. For example, in a hot environment, such as the American South West, if such an internal support structure is used on an outside wall of a house, the tremendous heat from the outside environment is transferred in part to the internal environment of the house. This can lead to extremely high temperatures inside the house, with obvious discomfort for occupants.

Presently, the solution used by many construction practitioners is to have one length of wood (or any support element), internally, closest to a first side of the wall, but not extending close to the opposing side of the wall (and therefore not transferring heat to the other side of the wall). Then a further support element, staggered further down the wall from the first support element (ie not aligned with the first support element) is provided close to the opposing side of the wall, but not extending close to the first side of the wall (and therefore not transferring heat to the first side of the wall). This can be complex to build in both labour and materials.

The present invention seeks to provide a solution to this problem, by providing, according to a first aspect of the invention, a wall support structure and thermal transfer reduction system, comprising: a first support element aligned and positioned closest to a first face of a wall; a second support element aligned and positioned closest to an opposing face of the wall; and a thermal transfer reduction spacer element aligned and positioned between the support elements.

Preferably, the spacer element and support elements are fixed together. This may be achieved, preferably via stapling and nail(s); however, the spacer element and support elements may be fixed together by any means under the sun, including, but not limited to, for example, adhering, glue, or any other fixing and/or bonding method and/or manner of any type.

Preferably the spacer element is engaged with the first support element and the second support element, whether by direct engagement, or via intervening element(s).

In one preferred embodiment, one of the support elements is a two by four length of wood, and the other support element is a two by two length of wood. These are readily available and cheap materials, particularly in the United States of America.

A ‘two-by-four’ (typically a term used in North America) is a piece of wood, typically soft wood used for construction. A two-by-four, originally, used to be two inches by four inches (rough cut). Nowadays, a two-by-four is an inch and a half by three and a half inches, and can come in various lengths. It is considered the most basic dimensional lumber for framing and building houses. A two-by two (also a piece of wood), originally, used to be two inches by two inches (rough cut). Nowadays, a two-by-two is an inch and a half by an inch and a half, and can come in various lengths. (Note: it is feasible that ‘two-by-four’ and/or ‘two-by two’ cuts may again change in dimension at any future point, whilst remaining within the scope of being called (and termed by industry) a ‘two-by-four’ and/or two-by-two).

The support elements and the spacer element may be aligned vertically, or horizontally, within the wall, (or feasibly in any orientation) dependent on the wall type.

Preferably the spacer element reduces thermal transfer between the support elements (and therefore between the first and opposing face of the wall) by comprising gaps, which helps dissipate heat (or cold).

A user (such as a construction practitioner) may, for example, staple the spacer element to the first support element, and the second support element may, for example, then be nailed together with the spacer element and first support element, thus forming a unit that can be easily used within the wall.

Alternatively, it is feasible the support elements and spacer element may come pre-prepared, pre-attached together, so that the user need not themselves attached the separate elements.

With reference to the present application, the term ‘closest’, when used to define the invention, is intended to mean ‘closest of the comprising elements listed’. Thus, when the first support element is defined as ‘closest’ to the first face of the wall, it is intended to define that the first support element is closest to the first face of the wall compared to the second support element and spacer element. Similarly, when the second support element is defined as ‘closest’ to the opposing face of the wall, it is intended to define that the second support element is closest to the opposing face of the wall compared to the first support element and spacer element.

According to a second aspect of the invention, referring to providing a pre-prepared wall support structure and thermal transfer reduction unit, there may be provided, and claimed, an all-in-one wall support structure and thermal transfer reduction unit, comprising: a first support element oriented in an orientation; a second support element oriented in the same orientation; and a thermal transfer reduction spacer element oriented in the same orientation, positioned between the support elements, wherein the spacer element is engaged with the first support element on a first side of the spacer element and engaged with the second support element on an opposing side of the spacer element; wherein the unit is provided with the support elements and spacer element pre-attached.

### BRIEF DESCRIPTION OF THE DRAWINGS

The present invention will now be more particularly described, with reference to the accompanying drawings, by way of example only and in no way limiting a scope of the invention, in which:

FIG. 1 is a birds-eye cross sectional view of one embodiment of a wall support structure and thermal transfer reduction system in accordance with a first aspect of the invention, showing a comparison view, where half of a wall is shown utilizing the invention, and half of the wall is shown using a standard arrangement, not using the invention;

FIG. 2 is a side cross sectional view of a wall using the wall support structure and thermal transfer reduction system, wherein support elements and spacer element are vertically arranged within the wall;

FIG. 3 is an exploded (or spaced apart) view of the wall support structure and thermal transfer reduction system, showing support elements and spacer element between the support elements;

FIG. 4 is a similar view and arrangement as shown in FIG. 2, wherein there are provided intervening elements between spacer element and the support elements;

FIG. 5 is a birds-eye cross sectional view of an embodiment of the wall support structure and thermal transfer reduction system, wherein the support elements and spacer element are horizontally arranged within the wall;

FIG. 6 is a similar birds-eye cross sectional view as shown in FIG. 5, wherein there are shown a plurality of layers of the wall support structure and thermal transfer reduction system horizontally layered between a first face and opposing face of the wall; and

FIG. 7 shows one method of how to fix elements of the wall support structure and thermal transfer reduction system together, featuring staples and nails.

### BRIEF DESCRIPTION OF THE DRAWINGS

Referring to the drawings, there is shown a wall support structure and thermal transfer reduction system 10, comprising: a first support element 12 aligned and positioned closest to a first face 14 of a wall 16; a second support element 18 aligned and positioned closest to an opposing face 20 of the wall 16; and a thermal transfer reduction spacer element 22 aligned and positioned between the support elements.

Preferably, the spacer element 22 and support elements 12, 18 are fixed together. This may be achieved by any means under the sun, including, but not limited to, for example, nail(s), staple(s), adhering, glue, or any other fixing and/or bonding method and/or manner of any type.

Preferably the spacer element 22 is engaged with the first support element 12 and the second support element 18, whether by direct engagement, or via intervening element(s).

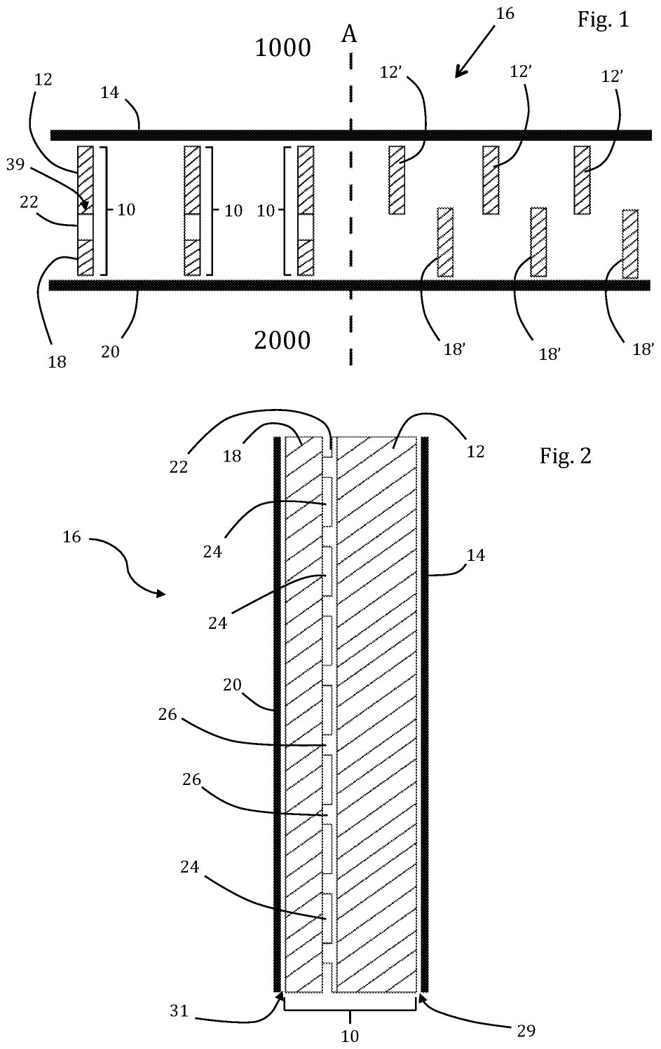

With reference to FIG. 1, an example birds-eye cut off cross-sectional view of a wall is shown. The wall is shown from a birds-eye view, as if sawn off on a horizontal axis, thereby showing internal elements of the wall. On a left side of the wall 16, (left of axis line A), the wall is shown having the wall support structure and thermal transfer reduction system 10 within. (Three examples of the wall support structure and thermal transfer reduction system 10 are shown within the wall). The system 10 (which may also be defined and claimed as an ‘arrangement’) is shown comprising the first support element 12 closest to the first face 14 of the wall 16, the second support element 18 closest to the opposing face 20 of the wall 16, and the thermal transfer reduction spacer element 22 in between the first and second support element. Alternatively, it will be obvious that the second support element 18 may in fact be defined as the first support element 12, and vice versa. Similarly, the first face 14 of the wall 16 may alternatively be defined as the opposing face of the wall 20, and vice versa.

In the example shown in FIG. 1, the support elements and spacer element are vertically aligned within the wall. (The term ‘vertically’ here should be read to mean either exactly vertical, or substantially vertical, such that it is clear the elements are oriented more vertically than horizontally).

As an example, the area generally defined by number 1000 may be an outside environment, whilst the area generally defined by number 2000 may be an inside environment of a house. However, the system 10 is not limited to use on outside walls of houses, and may be used, for example, within walls that are themselves located within buildings and/or houses, etc.

Referring still to FIG. 1, to a right side of axis line A, there is shown an arrangement for support structures, not using the invention 10. This is shown in order to show a comparison/difference with the wall support structure and thermal transfer reduction system 10. As shown, a staggered arrangement is shown, whereby there is shown a first support element 12′ (not forming part of the invention 10), but because a support element 12′ that extends close to the opposing face 20 of the wall 16 may lead to thermal transfer from the first face 14 of the wall to an opposing face 20 of the wall, a staggered arrangement is provided wherein a second support element 18′ (not forming part of the invention) is staggered from the first support element 12′. Three such examples of this staggered arrangement is shown.

The present invention 10 solves this problem by having the thermal transfer reduction spacer element 22, which is shown aligned and positioned between the support elements.

In one preferred embodiment, the first support element 12 is and/or comprises a two-by-four piece of wood. In one preferred embodiment, the second support element 18 is and/or comprises a two-by-two piece of wood. This arrangement may feasibly make a saving in terms of amount of support materials (ie support element matter) needed to support and/or add structural integrity to a wall.

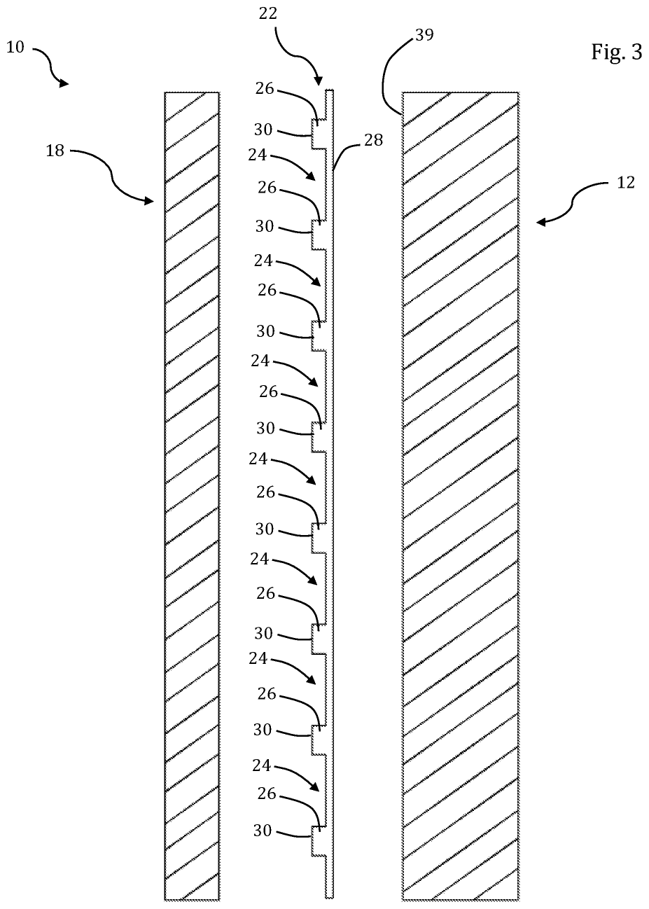

A side view of the wall support structure and thermal transfer reduction system 10 (aligned vertically within the wall 16) is shown in FIG. 2, where it can be seen that, in a preferred embodiment, the spacer element 22 comprises gaps 24. This is shown best in FIG. 3, where an exploded (or un-attached) view of the wall support structure and thermal transfer reduction system 10 is shown, where the spacer element and support elements are shown unengaged. It can be seen that, in the preferred embodiment of the spacer element, the spacer element comprises gaps 24. Preferably the spacer element also comprises peaks 26 between the gaps 24, which act as (and therefore are) engagement points, to facilitate engagement with the second support element (or first support element, dependent on direction the spacer element is faced, and which support element is defined as first or second support element, etc).

The gaps serve to dissipate any thermal energy/temperature (such as heat, or cold) to stop the thermal energy travelling between the support elements. Thus the system 10 reduces thermal transfer from the first face of the wall to the opposing face of the wall. Thus, if the invention is used in outside walls of a building located in a hot environment, the system 10 serves to protect the inside environment of the building from the hot outside temperatures.

It is also thought this arrangement could save on building materials, as less cubic volume of support elements may be required.

The spacer element, in the shown preferred embodiment, comprises gaps 24 and engagement points 26 on one side of the spacer element, and a spine 28 on an opposing side of the spacer element. The spine 28, in the shown embodiment, is shown in various Figures engaging with one of the support elements. The engagement points 26 (which may also be defined as peaks 26), in the shown embodiment, are shown in various Figures engaging with the other of the support elements. (It is feasible, in certain embodiments, that the spacer element may comprise engagement points on both sides of the spacer element, the engagement points of the first side of the spacer element engaging with one of the support elements, and the engagement points of the other side of the spacer element engaging with the other of the support elements).

The engagement points 26, in the shown embodiment, are shown having a flat engagement surface 30. This may be beneficial for engagement reasons. The engagement points 26 in the shown embodiment are shown being of cubic shape.

In the example preferred embodiment, the engagement points are shown being of rectangular shape.

As shown most clearly in FIG. 3, preferably the spacer element is elongate, and more preferably is provided as an elongate strip. Preferably the spacer element is elongate and flexible. Thus the spine (or all) of the spacer element may be flexible, which may aid application of the spacer element to the support element, for attaching/engagement.

There is shown in FIG. 2 (by way of example only, and for representational purposes only) an optional space 29 between the first support element and first wall face 14. In the example embodiment, the first wall face 14, may, for example, be an exterior wall face, on, for example, an outside of a building. In the space, there may be, for example, a vapour barrier, which is a term that will be understood to those with skill in the art. Therefore there may be matter between the first support element 12 and wall face 14. There is also shown an optional space 31 (shown by way of example only, and for representational purposes only) between the second support element and the opposing wall face 20 (which wall face 20, may, for example, be an inside wall face, inside a building). This space 31 is optional and it may, alternatively, be that there is provided no such space 31 and that the second support element 18 is directly engaged with plaster, etc that forms the opposing shown wall face 20.

It will be obvious to those with skill in the art that, preferably, all the shown elements (support elements and spacer element) are covered and/or surrounded by insulation, inside the wall. The insulation may be foam insulation, or any insulation of any type, and may completely surround the support elements and spacer element(s) inside the wall, such that, for example, it fills any spacer element gap(s) 24.

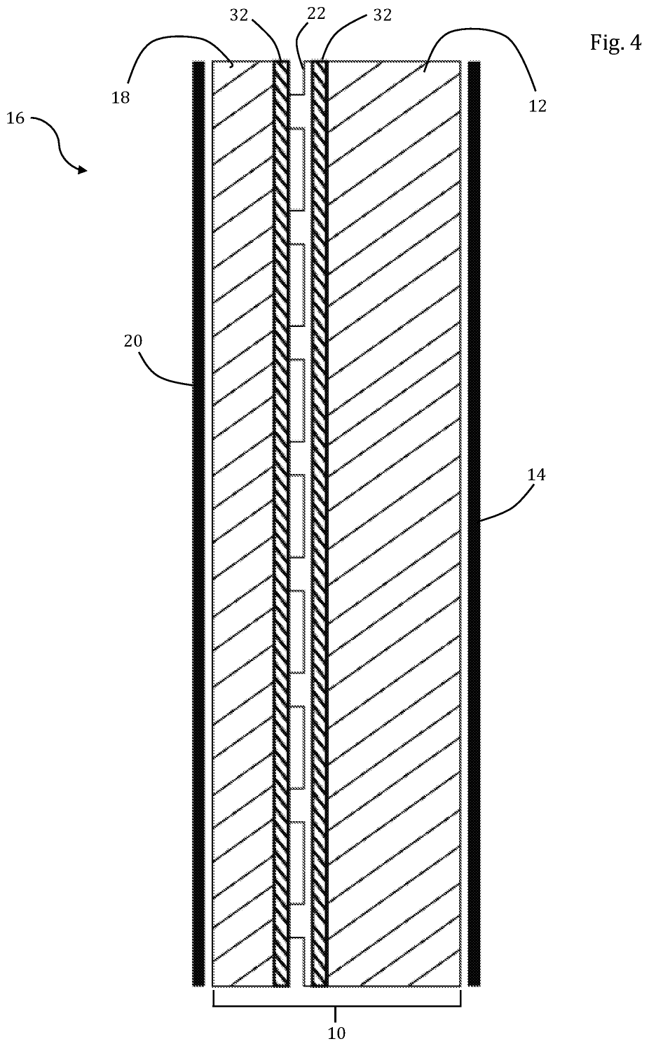

It is feasible there may be provided intervening element(s) between spacer element and any of the support elements. Thus there is shown in FIG. 4 an example of the wall support structure and thermal transfer reduction system 10 wherein there are shown intervening element(s) 32 between the spacer element and either or both of the support element(s). In the example embodiment, there are shown intervening elements 32 between the spacer element 22 and both of the support elements. It is also feasible there may be provided an embodiment wherein there is provided an intervening element(s) solely on one side of the spacer element. The intervening element(s) are shown in the example embodiment as elongate, and may, for example, (and given by way of example only) be lengths of material, carpet, board, or any matter under the Sun, not limited to the given examples.

The wall support structure and thermal transfer reduction system 10 as shown in FIG. 4 nevertheless falls within a scope of the present invention, because the intervening element(s) are considered, in such embodiments, to form part of the support element(s) and/or the spacer element. Thus, for the sake of the present application, referring to FIG. 4, the thermal transfer reduction spacer element is still considered to be aligned and positioned between the support elements, the spacer element engaged with the first support element and the second support element, because the (or any) intervening element is considered to form part of the support element and/or the spacer element it is in communication with.

In FIGS. 1 to 4, the support elements and spacer element are shown vertically oriented (ie in embodiments where the support elements and spacer element are vertically oriented within a wall). However, the support elements and spacer element may, in certain embodiments (and for use within certain walls, such as in headers), be horizontally oriented. (The term horizontally should be read as meaning exactly horizontal, or substantially horizontal, such that it is clear the elements are oriented more horizontally than vertically).

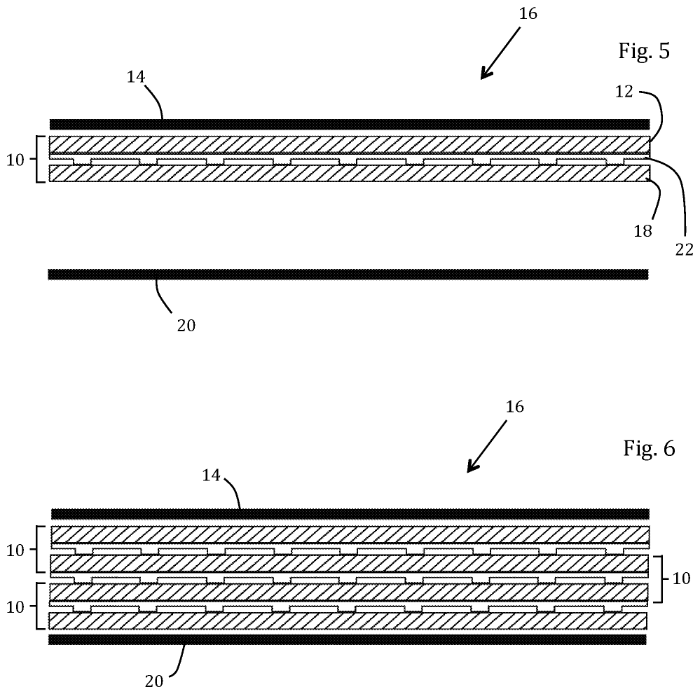

Thus there is shown an example horizontally oriented embodiment in FIG. 5, wherein there is shown a first face 14 of a wall 16, and an opposing face 20 of the wall 16, wherein the first support element is aligned and positioned (horizontally) closest to the first face of the wall; the second support element is aligned and positioned closest to the opposing face of the wall; and the thermal transfer reduction spacer element 22 is aligned and positioned between the support elements, the spacer element 22 engaged with the first support element and the second support element.

In such a horizontal embodiment as shown in FIG. 5 and FIG. 6, the support elements may again be two-by-fours and/or two-by-twos, etc (given by way of example only, and in no way limiting a scope of the invention).

The spacer element(s) (preferably in any or all embodiments) is preferably an inch and a half wide, to match edge width of the support elements, with the support element preferably being (or comprising) two-by-four's and/or two-by-two's, thus having an edge width of one and a half inches. (Support elements as shown are often referred to as ‘studs’ in the construction industry). Thus for headers, such as example embodiments as shown in FIG. 5 and FIG. 6, preferably a plurality of rows of spacers are used between each support element. Thus, for example, referring to FIG. 5, where one spacer element is visible from the birds-eye-view, there may in fact be a further spacer element located directly underneath the visibly shown spacer element. On top of its other functional benefits (already discussed), this may add stability between the support elements when the support elements (eg two-by fours) are oriented in such a way as shown in FIG. 5 or FIG. 6).

Thus the one and a half inch top edge (if, for example, the support elements are two-by-fours), of each support element is shown facing upwards in FIG. 5 and FIG. 6. The support elements (if they are two-by fours) then descend three and a half inches downwards (from the birds-eye top view. Thus it will be clear that, if the spacer element(s) are only an inch and a half wide (eg elongate strip(s), long in length, but only an inch and a half wide), it may be beneficial (or necessary) to use a plurality of spacer elements in the gaps between the support elements shown in FIG. 5 and FIG. 6, which may be beneficial for stabilizing the support elements. Thus, if the support elements descend three and a half inches, for example, in a horizontal embodiment (eg for use within a header as shown in FIG. 5 and FIG. 6, then two rows of spacer elements may be used between each support element (each spacer element preferably being one and a half inches wide, with two spacer elements thus fitting well within such an example three and a half inches width of the support element). Thus the possible feature of the rows of spacer elements being provided between the first support element and the second support element is preferably provided in FIG. 5 and FIG. 6, where at least one further spacer element is preferably provided underneath the shown spacer elements that are shown between the support elements.

Headers (over windows and doors), in a horizontal orientation, preferably use a same size support element as size of the header, preferably with two rows of spacers in between support elements if two-by-four's are used as support elements, and preferably with three rows of spacer elements in between support elements if two-by-sixes are used as support elements.

In FIG. 6, there is shown a similar horizontal embodiment as that shown in FIG. 5, wherein there are shown multiple layers of the wall support structure and thermal transfer reduction system 10, horizontally layered within the wall 16. In the example shown, there is shown what amounts to three layers of the invention (including three separate spacer elements 22) within the wall. But there may be any number of layers-for example, there may be two layers, or any number.

In a preferred embodiment, in use, the spacer element is stapled to the first support element (this may be achieved via a staple gun, etc, or any machine/apparatus/method to achieve stapling), so that, preferably, the spine 28 is stapled and attached to the support element. Preferably the second support element is then nailed through the spacer element, into the first support element (which spacer element and first support element are stapled together, attached), thus forming an embodiment of the invention. The second support element may be nailed in such a way that the nail(s) pierce all three elements (through the second support element, and through/into the spacer element, and into the first support element, thus attaching and second support element to the first support element, with the nail(s) penetrating through the spacer element, between the support elements). This may, for example, be achieved with a nail gun, (or any machine/apparatus/method to achieve nailing).

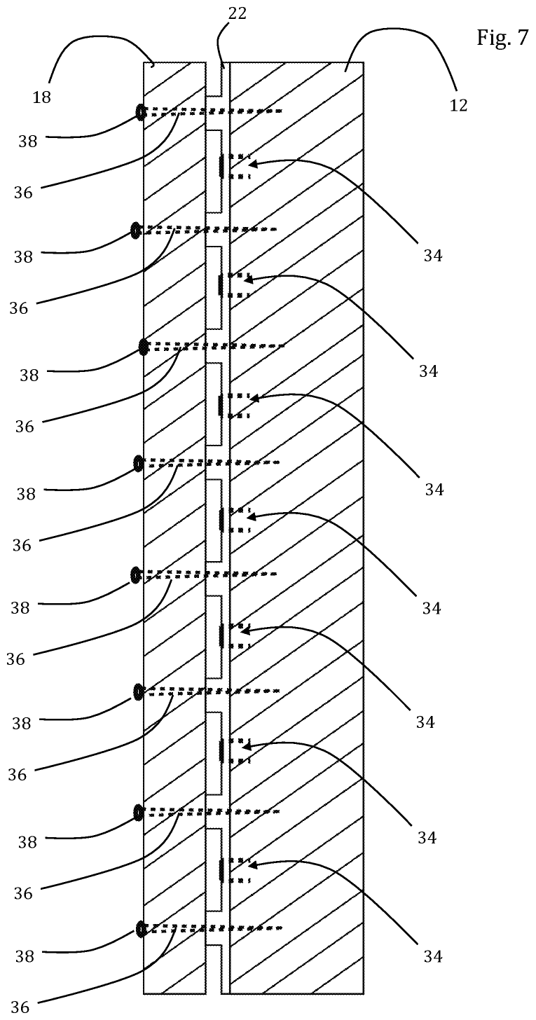

Such a preferred method of fixing the support elements and spacer element together is shown in FIG. 7, wherein the spacer element 22 is shown stapled to the first support element 12. The staple(s), in the shown example embodiment, staple the spine of the spacer element to the interior edge 39 of the first support element. The staple(s) (there may be provided any number of staples), in the example embodiment, are located at the gap 24 area(s) of the spacer element. Once the spacer element 22 is attached to the first support element, in the preferred embodiment, as shown, the second support element is nailed to the spacer element and first support element. Thus nail(s) 36 are shown. A nail head 38 is shown (by way of example). Body of the nail 36 has penetrated through the spacer element 22, into the first support element 12, thus fixing the unit together.

Thus preferably, (preferably via stapling and/or nailing, and/or any other means), the spacer element is attached to the first support element (eg via stapling), and the second support element is attached (preferably via nailing) to the second first element, via the spacer element (eg by nailing through the spacer element). In an alternate embodiment, it is feasible the second support element is attached (by any means) to the spacer element (which, itself, may be attached (by any means) to the first support element).

The support elements and spacer element may come/be provided as a pre-prepared all-in-one unit, whereby, rather than the user (ie construction worker/person) having to attach the elements together, the support elements and spacer element are provided, pre-attached together, as a pre-prepared unit, ready for use.

### In Use

The invention will now be described in use, with reference to one preferred embodiment of the invention, and in no way limiting a scope of the invention. Thus, in use, by way of example, in remodelling of a wall (for example, to make a wall thicker), one may remove an interior sheeprock from a wall, the spacer element may be stapled to an interior edge of the support element (the support elements preferably being attached (eg stapled/nailed) to top and bottom plates of the wall. (The term ‘plates’ will be well known to those with skill in the art of construction and wall construction in particular, where a wall tends to have a top plate, and a bottom plate, with ‘studs’ (ie support elements) attached to the plates at top and bottom, within the wall). Using a two by two the same length of the first support element (which support element may be typically referred to as a ‘stud’ in construction terms, and which is preferably a two-by-four), the two-by-two is nailed through the spacer element, and into the stud. (Preferably the nail(s) are nailed through the engagement point parts (rather than the gaps) of the spacer element. Preferably the process is then repeated for all studs/support elements to secure both support elements (eg two-by-four and two-by-two) together.

Then also, preferably the same is done for the top and bottom plates. Preferably the same process is used (eg on a horizontal axis for top and bottom plates of the wall, at top and bottom extremities of the support elements. Thus, for example, a two by two plate(s) on the second support element side may be nailed through a spacer element and into the first support element plate(s) (at top and bottom of wall) with a spacer element thereby fixed between the plates.

The embodiments described above are provided by way of example only, and various other modifications will be apparent to persons skilled in the art without departing from the scope of the invention as defined in the appended claims.

The appended claims define limited inventions. However, it should be recognized and understood that the disclosure of the present application includes a vast array of inventions, not limited to inventions set out in the appended claims.

For example, if the present disclosure of the present application (inclusive of drawing(s) and/or description) discloses features a to z, it should be recognized and understood that any invention may be claimed, comprising any feature(s) out of features a to z. Thus if the appended claim 1 defines the invention claimed as comprising essential features a, b, and c, it should be understood that an invention may be claimed comprising solely feature a, or solely feature b, or solely feature c, or any combination of features a, b, and c. Furthermore, it should be understood that an invention may be claimed comprising any of feature(s) d to z, whether or not also comprising any of features a, b, or c.

A final claim is appended which serves to signify that I reserve the right to claim any invention, comprising any feature, or combination of features, disclosed in the present application (inclusive of drawing(s) and/or description). This statement (and/or final appended claim), if so desired, should be seen as a statement of invention, stating any invention, comprising any feature(s) disclosed in the present application. It is intended (or plausible) that such invention(s) may be claimed in a future application(s) which claims benefit of priority of the present application. The present disclosure of the present application supports such invention(s)/claim(s).

1. A wall support structure and thermal transfer reduction system, comprising:
a first support element aligned and positioned closest to a first face of a wall;
a second support element aligned and positioned closest to an opposing face of the wall; and
a thermal transfer reduction spacer element aligned and positioned between the support elements.

2. A wall support structure and thermal transfer reduction system as claimed in claim 1, wherein the support elements and spacer element are fixed together.

3. A wall support structure and thermal transfer reduction system as claimed in claim 2, wherein the spacer element is engaged with the first support element and the second support element.

4. A wall support structure and thermal transfer reduction system as claimed in claim 1, wherein the first support element comprises a two by four.

5. A wall support structure and thermal transfer reduction system as claimed in claim 4, wherein the second support element comprises a two by two.

6. A wall support structure and thermal transfer reduction system as claimed in claim 1, wherein the spacer element comprises gaps to facilitate thermal transfer reduction.

7. A wall support structure and thermal transfer reduction system as claimed in claim 6, wherein the spacer element comprises engagement points between the gaps.

8. A wall support structure and thermal transfer reduction system as claimed in claim 1, wherein the spacer element is an elongate strip.

9. A wall support structure and thermal transfer reduction system as claimed in claim 1, wherein the support elements and spacer element are vertically oriented within the wall, the support elements aligned perpendicular with reference to the wall face.

10. A wall support structure and thermal transfer reduction system as claimed in claim 1, wherein the support elements and spacer element are horizontally oriented within the wall, the support elements aligned parallel with reference to the wall face.

11. A wall support structure and thermal transfer reduction system as claimed in claim 1, wherein the spacer element is stapled to the first support element, and the second support element is nailed into the first support element through the spacer element.

12. A wall support structure and thermal transfer reduction system as claimed in claim 1, wherein the internal wall support structure and temperature transfer reduction system is provided as a pre-prepared all-in-one unit.

13. An all-in-one wall support structure and thermal transfer reduction unit, comprising:
a first support element oriented in an orientation;
a second support element oriented in the same orientation; and
a thermal transfer reduction spacer element oriented in the same orientation, positioned between the support elements, wherein the spacer element is engaged with the first support element on a first side of the spacer element and engaged with the second support element on an opposing side of the spacer element;
wherein the unit is provided with the support elements and spacer element pre-attached.

14. Any novel subject matter or combination including novel subject matter disclosed herein, whether or not within the scope of or relating to the same invention as claimed in claim 1.
